(19) United States
(12) Patent Application Publication
(10) Pub. No.: US 2026/0183173 A1
(43) Pub. Date: Jul. 2, 2026

(54) AIR STRETCHING DEVICE COMPRISING BELT AND MATTRESS

(71) Applicant: CERAGEM CO., LTD., Cheonan-si (KR)

(72) Inventors: Ki-Won LEE, Cheonan-si (KR); Mi-Hyun LEE, Cheonan-si (KR); Ji-Hye KIM, Cheonan-si (KR)

(21) Appl. No.: 19/450,328

(22) Filed: Jan. 15, 2026

Related U.S. Application Data
(63) Continuation of application No. PCT/KR2024/008451, filed on Jun. 19, 2024.

(30) Foreign Application Priority Data
Aug. 7, 2023 (KR) 10-2023-0103159

(51) Int. Cl. A61H 1/02; A61H 9/00; A61H 11/00; A61H 15/00

(52) U.S. Cl. CPC A61H 1/0292; A61H 9/0092; A61H 11/00; A61H 15/0078; A61H 2011/005; A61H 2015/0014; A61H 2201/0176; A61H 2201/0207; A61H 2201/10; A61H 2201/169

(57) ABSTRACT

Provided is an air stretching device comprising: a control unit; a plurality of air chambers controlled by the control unit such that the air pressure thereof increases or decreases and including lumbar-region air chambers corresponding to the lumbar region of a user; and an air belt which can be worn around the lumbar region of the user and has a plurality of air tubes extending longitudinally thereof, wherein the control unit comprises an air pump that is connected to the air tubes and can inject air.

### CROSS-REFERENCE TO RELATED APPLICATION

This application is a Continuation of PCT application No. PCT/KR2024/008451 filed on Jun. 19, 2024, which is based upon and claims the benefit of priority to Korean Patent Application No. 10-2023-0103159 filed on Aug. 7, 2023, in the Korean Intellectual Property Office. All of the aforementioned applications are hereby incorporated by reference in their entireties.

### TECHNICAL FIELD

This research was supported by a grant of Korean ARPA-H Project through the Korea Health Industry Development Institute (KHIDI), funded by the Ministry of Health & Welfare, Republic of Korea (grant number: RS-2024-00512384).
Project Number: RS-2024-00512384
Sub-project Number: RS-2024-00512384
Ministry: Ministry of Health and Welfare
Research Management Agency: Korea Health Industry Development Institute
Research Program: Mission-oriented R&D
Research Project Title: Fluid Shift Technology Driven Diagnostics and Therapeutic Techniques for Central Nervous System Diseases
Lead Institution: Korea Advanced Institute of Science and Technology (KAIST)
Research Period: 2024 Nov. 1˜2029 Feb. 28

The present invention relates to an air stretching device that uses air pressure to massage and stretch a user and includes an air belt and an air mattress, and an air stretching method using the same.

### BACKGROUND ART

Spinal diseases affect the muscles, nerves, and intervertebral discs around the spine, and examples thereof include herniated discs, spondylolisthesis, spondylolysis, spinal stenosis, scoliosis, sprains, etc.

These spinal diseases can occur acutely due to a strong shock, but are often chronically caused by poor posture or the like. Accordingly, in order to prevent and treat most of these spinal diseases and relieve pain, relaxing and stretching the muscles around the spine is recommended.

Recently, a number of air stretching mats have been released to assist in stretching the muscles around the spine.

FIG. 1 illustrates the structure of a typical air stretching mat. Referring to this, a typical air stretching mat 1 includes a plurality of air chambers 11, 12, 13, and 14 and a control unit 15 for controlling the air pressure injected into the air chambers. The air chambers may include a cervical air chamber 11, a thoracic-region air chamber 12, a lumbar-region air chamber 13, and a sacrococcygeal-region air chamber 14, each of which corresponds to a specific spinal region, and depending on the product, some may be omitted or added. As air pressure is dynamically supplied to and released from the plurality of air chambers, the muscles around the user's spine may be stretched by being pulled or twisted.

Meanwhile, for patients with herniated intervertebral discs, commonly known as cervical disc herniation and lumbar disc herniation, it is known that applying traction to the spine to reduce pressure on the intervertebral discs is highly effective for treatment.

Traction therapy includes intermittent traction, in which spinal traction is applied for about 7 seconds followed by a rest period of about 5 to 7 seconds and repeated, and continuous traction, in which the spine is gently pulled with a weak force for several tens of minutes. Since the effectiveness of intermittent traction and continuous traction may vary depending on the affected area, symptoms, and individual patients, treatment of herniated intervertebral discs requires appropriately selecting and performing intermittent traction or continuous traction, or combining them if necessary.

In the air stretching mat 1, the cervical air chamber 11 and the lumbar-region air chamber 13 may provide this air pressure-based traction effect. In the case of the air stretching mat 1, since air pressure may be freely supplied and released and the air stretching mat 1 does not completely enclose the spine, intermittent traction is preferred, and for the continuous traction, a belt-shaped product, which will be described below, may be used.

FIG. 2 illustrates the structure of a typical air belt. Referring to this, an air belt 2 is typically worn tightly around the user's waist and fixed by a fixing unit such as a Velcro 21 or the like. The air belt 2 has a plurality of air tubes 22 extending longitudinally. The air tube 22 may expand longitudinally when air is injected, providing the continuous traction to the lumbar region of the user.

However, it is difficult to perform the intermittent traction and the continuous traction simultaneously or alternately with the home devices. In addition, for patients whose pain is triggered by changes in posture, dynamic stretching may further exacerbate the pain, and using a belt to maintain posture may limit dynamic stretching movements.

### DISCLOSURE

### Technical Problem

The present invention has been devised under the background of the above related art and is directed to providing an air stretching device and an air stretching method using the same, which easily perform continuous traction and intermittent traction simultaneously or alternately.

The present invention is also directed to providing an air stretching device and method for minimizing pain caused by rapid postural changes while performing dynamic stretching to relax muscles around the spine.

The present invention is also directed to providing an air stretching device and method for assisting stimulation and relaxation of deep muscles to relieve menstrual pain and the like.

The present invention is also directed to providing a structure for an air stretching device for preventing problems caused by excessive air pressure, such as lumbar hyperextension and the like, when using an air belt and an air stretching mat together or separately, and for sufficiently exerting a heating effect.

Objects of the present invention are not limited to the above objects, and other objects and advantages of the present invention which are not described can be understood by the following description and more clearly understood by various embodiments of the present invention. In addition, it will be able to be easily seen that the objects and advantages of the present invention may be achieved by devices and combinations thereof that are described in the claims.

### Technical Solution

In order to achieve the objects, the present invention provides an air stretching device including a control unit, a plurality of air chambers controlled by the control unit such that an air pressure thereof increases or decreases and including lumbar region air chambers corresponding to a lumbar region of a user, and an air belt which is wearable around the lumbar region of the user and has a plurality of air tubes, wherein the control unit includes an air pump which is connected to the air tubes and enables air injection.

The air belt may include a low-frequency stimulation pad which is provided on an inner surface thereof and provides heating and low-frequency electrical stimulation to the user. The low-frequency stimulation pad can provide heating and low-frequency electrical stimulation to stimulate the user's deep muscles, improve blood flow, and relieve muscle pain or menstrual cramps. The low-frequency stimulation pad may have a heating function or include a separate heating device.

The air belt may include a belt operation unit configured to adjust an intensity of the heating and low-frequency electrical stimulation provided by the low-frequency stimulation pad. The user may control the intensity, site, cycle, duration, etc. of the heating and low-frequency electrical stimulation of the low-frequency stimulation pad by operating the belt operation unit.

The air tube may be provided as a plurality of air tubes. The plurality of air tubes may be connected so that air pressure communicates with each other. The plurality of air tubes may be arranged longitudinally or transversely.

The shape of the air tube is preferably a longitudinally extending shape, but is not limited thereto.

The control unit may block the air injection when a predetermined appropriate air pressure is injected into the air tubes.

The air stretching device may detect a user wearing the air belt. Specifically, the control unit may detect the user wearing the air belt and lying on the air stretching device.

A belt detection sensor connected to the control unit may be provided on a surface of the lumbar-region air chamber. In this case, a belt detection target may be provided on a back surface of the air belt, and thus, the belt detection sensor may detect that the belt detection target comes into contact with the belt detection sensor or approaches within a predetermined distance from the belt detection sensor and output a belt detection signal to the control unit. When receiving the belt detection signal, the control unit may detect the user wearing the air belt and lying on the air stretching device.

Alternatively, a belt detection sensor connected to the control unit may be provided on the back surface of the air belt. In this case, a belt detection target may be provided on a surface of the lumbar-region air chamber, and thus, the belt detection sensor may detect that the belt detection target comes into contact with the belt detection sensor or approaches within a predetermined distance from the belt detection sensor and output a belt detection signal to the control unit. When receiving the belt detection signal, the control unit may detect the user who wears the air belt and lies on the air stretching device.

The belt detection sensor and the belt detection target may be provided at corresponding widthwise centers and are preferably formed to extend in the longitudinal direction or as multiple units.

The belt detection target may include an electrostatic tag, and the belt detection sensor may include an electrostatic sensor for detecting contact or approach of the electrostatic tag.

Since the air stretching device may detect the user wearing the air belt, the air stretching device may operate differently depending on whether the user wears the air belt. The air pressure injected into the lumbar-region air chamber by the control unit may be controlled to be a predetermined maximum air pressure or lower, and in this case, when the user does not wear the air belt, the maximum air pressure may be controlled to be a first maximum pressure or lower, and when the user wears the air belt, the maximum air pressure may be controlled to be lower than or equal to a second maximum pressure that is lower than the first maximum pressure.

When the user wears the air belt and lies on the air stretching device, the air pump may be controlled to inject air into the air belt. Specifically, the control unit may detect the user wearing the air belt and lying on the air stretching device and control the air pump to inject air into the air belt.

The air stretching device may detect hyperextension of the lumbar region of the user. Specifically, the control unit may detect the hyperextension of the lumbar region of the user due to the pressure provided to the lumbar region by the lumbar-region air chamber and the air belt when the user wears the air belt and uses the air stretching device.

A pair of hyperextension detection sensors may be provided at positions spaced apart from each other by a predetermined distance on both sides of a widthwise center of a surface of the lumbar-region air chamber. In this case, a pair of hyperextension detection targets may be provided at positions spaced apart from each other by a predetermined distance on both sides of the widthwise center of the back surface of the air belt, and thus, the hyperextension detection sensor may detect that the hyperextension detection target comes into contact with the hyperextension detection sensor or approaches within a predetermined distance from the hyperextension detection sensor and output a hyperextension detection signal to the control unit.

In contrast, a pair of hyperextension detection sensors may be provided at positions spaced apart from each other by a predetermined distance on both sides of the widthwise center of the surface of the lumbar-region air chamber. In this case, a pair of hyperextension detection targets may be provided at positions spaced apart from each other by a predetermined distance on both sides of the widthwise center of the back surface of the air belt, and thus, the hyperextension detection sensor may detect that the hyperextension detection target comes into contact with the hyperextension detection sensor or approaches within a predetermined distance from the hyperextension detection sensor and output a hyperextension detection signal to the control unit.

The hyperextension detection sensor and the hyperextension detection target may be provided in a pair or multiple pairs at corresponding positions and are preferably formed to extend longitudinally or as multiple units.

The air stretching device may control the lumbar-region air chamber to no longer inject air when hyperextension of the lumbar region of the user is detected. That is, when the hyperextension of the lumbar region of the user is detected, the air stretching device may control the lumbar-region air chamber not to increase any more or to decrease the pressure provided to the lumbar region of the user, thereby preventing the hyperextension of the lumbar region of the user.

The air stretching device may include a lower mat whose temperature is controlled by the control unit to increase or decrease, and an upper mat provided above the lower mat. In this case, the upper mat may include at least one of ceramic, artificial stone, and natural stone, thereby achieving a better transfer of heat from the lower mat to the user.

The air belt may include a copper material. Accordingly, the air belt can have high thermal conductivity, and even when the user wears the air belt, the heating effect from the lower mat can be better transferred to the user.

The air belt may include a roller controlled by the control unit to rotate and travel. The roller is preferably provided at a position corresponding to a cervical region of the user, but may be formed anywhere as long as it may massage the muscles around the user's spine.

The present invention provides an air stretching method using an air stretching device including a control unit, and a lumbar-region air chamber controlled by the control unit to increase or decrease air pressure and corresponding to a lumbar region of a user, which includes a traction operation of maintaining, by the lumbar-region air chamber, an air pressure at a predetermined traction pressure or higher for a predetermined traction time, and a resting operation of maintaining, by the lumbar-region air chamber, an air pressure at a predetermined rest pressure or lower for a predetermined rest time.

In this case, the air stretching device may include an air belt that is wearable around the lumbar region of the user and has a plurality of air tubes, and in the air stretching method, when the user does not wear the air belt, the traction pressure may be controlled to be a first traction pressure or higher, and when the user wears the air belt, the traction pressure may be controlled to be higher than or equal to a second traction pressure that is lower than the first traction pressure.

In addition, in this case, the air stretching device may include a thoracic-region air chamber corresponding to a thoracic region of the user, and a sacrococcygeal-region air chamber corresponding to sacral and coccyx regions of the user, and may further include a posture change assisting operation of increasing an air pressure on one side in a left-right direction compared to an air pressure on the other side in at least one of the thoracic-region air chamber and the sacrococcygeal-region air chamber.

### Advantageous Effects

The present invention can provide the air stretching device and the air stretching method using the same, which easily perform continuous traction and intermittent traction simultaneously or alternately in conjunction with the air belt, which maintains a constant air pressure, and the air stretching mat whose air pressure is dynamically controlled to increase.

The present invention can also provide the air stretching device and method for minimizing pain caused by rapid posture changes by firmly fixing the lumbar region using the air belt even during dynamic stretching using the air stretching mat.

As yet another advantage of the present invention, the heat and low-frequency stimulation pads provided on the air belt can stimulate and relax deep muscles to relieve conditions such as menstrual cramps.

As yet another advantage of the present invention, by appropriately selecting the materials for the air belt and air stretching mat, even when the air belt and the air stretching mat are simultaneously used, sufficient heat can be transferred to the user, and the air pressure can be controlled to prevent excessive pressure depending on whether the belt is worn or hyperextended, thereby enhancing effectiveness and improving safety.

In addition, the present invention may have various other effects, which will be described in each embodiment, or the description of effects that can be easily inferred by those skilled in the art will be omitted.

### DESCRIPTION OF DRAWINGS

FIG. 1 illustrates the structure of a typical air stretching mat.

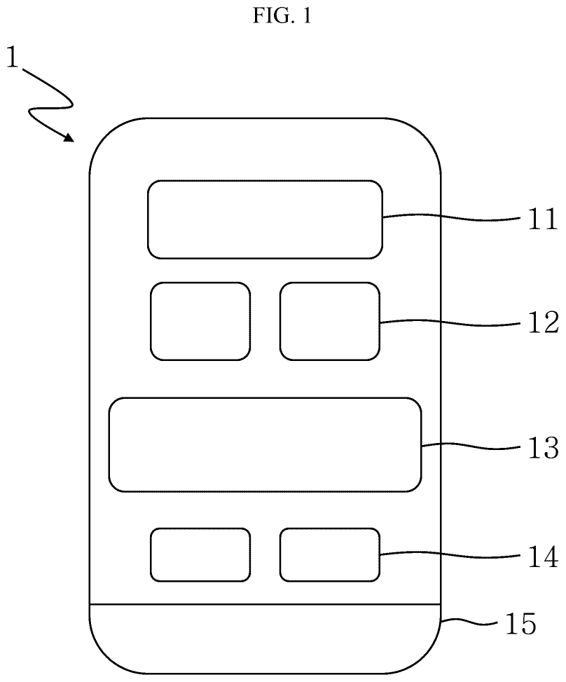

FIG. 2 illustrates the structure of a typical air belt.

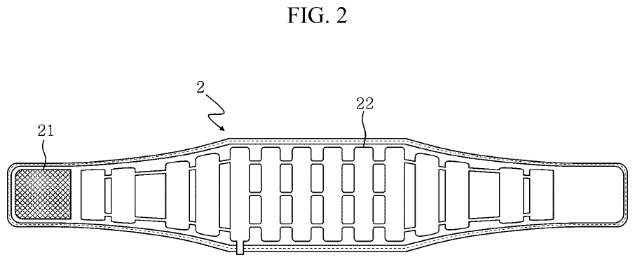

FIG. 3 illustrates the structure of an air stretching mat according to one embodiment of the present invention.

FIGS. 4 and 5 illustrate front and rear structures of an air belt according to one embodiment of the present invention, respectively.

FIG. 6 illustrates a combined air stretching mat and air belt according to one embodiment of the present invention.

FIGS. 7 and 8 illustrate a hyperextension detection function according to one embodiment of the present invention.

FIGS. 9 and 10 are graphs illustrating the pressure applied to a lumbar region of a user over time in an air stretching method according to one embodiment of the present invention.

FIG. 11 illustrates a posture change assisting operation in the air stretching method according to one embodiment of the present invention.

### DESCRIPTION OF REFERENCE NUMERALS

1: air stretching mat
11: cervical air chamber
111: roller
12: thoracic-region air chamber
13: lumbar-region air chamber
131: belt detection sensor
132: hyperextension detection sensor
14: sacrococcygeal-region air chamber
15: control unit
151: air pump
2: air belt
21: Velcro
22: air tube
231: belt detection target
232: hyperextension detection target
240: belt operation unit
241: low-frequency stimulation pad
242: heating device
25: LED
Pt: set traction pressure
Pr: set rest pressure
P1: first traction pressure
P2: second traction pressure
P3: belt traction pressure

### MODE FOR INVENTION

The above-described objects, features, and advantages will be described below in detail with reference to the accompanying drawings, and thus those skilled in the art to which the present disclosure pertains will be able to easily carry out the technical spirit of the present disclosure. In describing the present invention, when it is determined that a detailed description of the known technology related to the present invention may unnecessarily obscure the gist of the present invention, a detailed description thereof will be omitted. Hereinafter, exemplary embodiments according to the present invention will be described in detail with reference to the accompanying drawings. In the drawings, the same reference numerals are used to denote the same or similar components.

Although “first,” “second,” and the like are used to describe various components, these components are not limited by these terms. These terms are used only to distinguish one component from another, and unless otherwise stated, it is obvious that a first component may be a second component.

Throughout the specification, unless otherwise stated, each component may be singular or plural.

Hereinafter, the arrangement of an arbitrary component on an “upper portion (or lower portion)” of a component or “above (or under)” the component may not only mean that the arbitrary component is disposed in contact with an upper surface (or a lower surface) of the component, but also mean that other components may be interposed between the component and the arbitrary component disposed above (or under) the component.

In addition, when a certain component is described as being “connected,” “coupled,” or “joined” to the other component, the components may be directly connected or joined, but it should be understood that another component may be “interposed” between the components, or the components may be “connected,” “coupled,” or “joined” through another component.

The singular expression used herein includes the plural expression unless the context clearly dictates otherwise. In the application, terms such as “composed of” or “comprising” should not be construed as necessarily including all of the various components or operations described in the specification and should be construed as not including some of the components or some of the operations or further including additional components or operations.

Throughout the specification, when “A and/or B” is described, this means A, B, or A and B unless otherwise specified, and when “C to D” is described, this means C or more and D or less unless otherwise specified.

Hereinafter, exemplary embodiments of the present invention will be described in detail with reference to the accompanying drawings.

### Air Stretching Device

First, the structure of an air stretching device according to one embodiment of the present invention will be described with reference to the drawings.

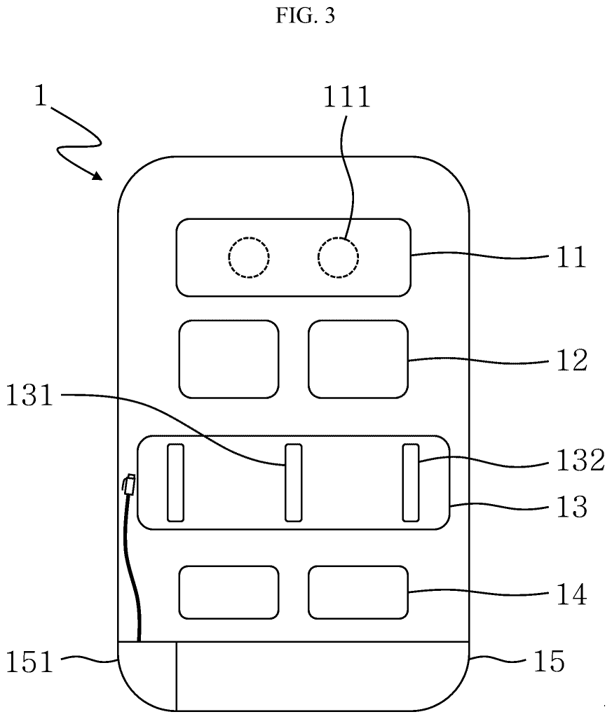

FIG. 3 illustrates the structure of an air stretching mat according to one embodiment of the present invention. Referring to this, an air stretching device according to one embodiment of the present invention may include an air stretching mat 1, and the air stretching mat 1 may include a plurality of air chambers 11, 12, 13, and 14 and a control unit 15.

The air chambers 11, 12, 13, and 14 may be controlled to expand or contract as an internal air pressure increases or decreases. The control may be performed by the control unit 15.

The air chambers 11, 12, 13, and 14 are preferably formed to be symmetrical on both sides, such as by separately adjusting the air pressure on the left and right sides, simultaneously adjusting the air pressure on both sides except for a central portion, or by providing one on each side.

The air chambers 11, 12, 13, and 14 may include at least one of a cervical air chamber 11, a thoracic-region air chamber 12, a lumbar-region air chamber 13, and a sacrococcygeal-region air chamber 14. The cervical air chamber 11, the thoracic-region air chamber 12, the lumbar-region air chamber 13, and the sacrococcygeal-region air chamber 14 may be provided at positions corresponding to cervical, thoracic, lumbar, and sacrococcygeal regions of a user, respectively.

The air stretching mat 1 may include a roller 111. The roller 111 may be controlled to rotate and travel, thereby massaging the muscles around the user's spine. The control may be performed by the control unit 15.

The roller 111 may be positioned anywhere along the muscles around the user's spine, but is preferably provided in a region corresponding to the cervical region of the user.

The control unit 15 may independently control the air pressure of the air chambers 11, 12, 13, and 14 according to a program or the user's operation, thereby expanding and contracting the air chambers, thereby applying pressure to a specific part of the user's body or changing the user's posture.

The control unit 15 may include an air pump 151. The air pump 151 may inject air into an air belt to be described below.

The air stretching mat 1 may also include a heating device to provide a heating effect to the user. The heating device may be a surface heating element provided below the air stretching mat 1, but is not limited thereto, and any structure may be used as long as it may transmit heat to the user lying on the air stretching mat 1.

The air stretching mat 1 may include at least one of ceramic, artificial stone, and natural stone to efficiently transfer heat from the heating device to the user. Specifically, the air stretching mat 1 may include a lower mat provided with the heating device and controlled to increase or decrease temperature by the control unit, and an upper mat provided above the lower mat, and the upper mat may include at least one of ceramic, artificial stone, and natural stone.

The air stretching mat 1 according to one embodiment of the present invention may include the control unit 15, an integrated cervical air chamber 11 and lumbar-region air chamber 13 whose air pressure is separately controlled by the control unit 15, the thoracic-region air chamber 12 and the sacrococcygeal-region air chamber 14 whose air pressure is separately controlled by the control unit 15 and formed as a pair of left and right separate parts, and the ceramic 111 provided to correspond to the cervical region of the user and further include a heating device for providing a heating effect to the user.

According to the present embodiment, the air stretching mat 1 may dynamically change the user's posture or apply pressure to the user's specific parts as the air chambers 11, 12, 13, and 14 independently expand and contract under the control of the control unit 15, thereby massaging or stretching the muscles around the user's spine to relax the muscles. In addition, the air stretching mat 1 may provide the user with a heating effect in addition to the massage, thereby assisting in relaxing the user's muscles and improving blood flow, thereby promoting health and recovery.

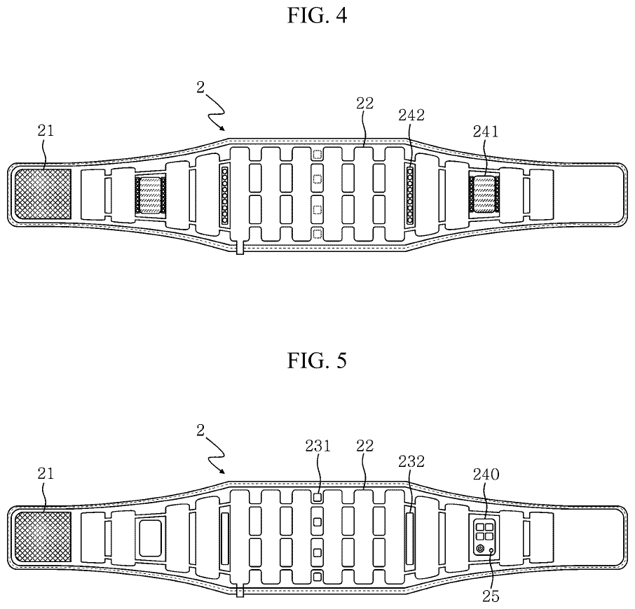

FIGS. 4 and 5 illustrate front and rear structures of an air belt according to one embodiment of the present invention, respectively. That is, FIGS. 4 and 5 illustrate back and front structures of the air belt according to one embodiment of the present invention, respectively. Referring to these drawings, the air stretching device may include the air belt 2, and the air belt 2 may be formed to extend horizontally and provided to be surrounded around the lumbar region of the user.

The air belt 2 may include a fixing unit for fixing both ends of the air belt 2. The fixing unit may include, for example, Velcro 21 that may be provided on one end portion of a horizontal surface of the air belt 2 and the other end portion of the horizontal back surface of the air belt 2 to be attached to each other.

The air belt 2 may include an air tube 22. The air tube 22 may extend longitudinally and may be provided as a plurality of air tubes arranged horizontally. However, the shape and arrangement of the air tube 22 are not limited thereto, and may, for example, extend laterally or may be arranged longitudinally.

The air tube 22 may be filled with air. As the air tube 22 is filled with air, the air tube 22 may expand longitudinally. As the air tube 22 expands longitudinally, the air belt 2 may apply continuous traction by longitudinally tensioning the lumbar region of a user wearing the same and fix the lumbar region of the user so as to prevent the lumbar region from being bent, folded, or twisted.

Referring to FIG. 4, the air belt 2 may include a low-frequency stimulation pad 241 that is provided on an inner surface thereof and applies a low-frequency voltage to the user's skin surface to provide low-frequency electrical stimulation. The low-frequency stimulation pad 241 may be provided at a position corresponding to the back or front side of the user. The low-frequency stimulation pads 241 may be provided as a pair symmetrically on both sides in the horizontal direction. The low-frequency stimulation pads 241 can relieve the user's muscle pain or menstrual cramps by stimulating the user's deep muscles through the low-frequency voltage.

Referring back to FIG. 4, the air belt 2 may include a heating device 242 which is provided on the inner surface thereof and provides a heating effect to the user.

The heating device 242 may be provided together with the low-frequency stimulation pad 241. The heating device 242 may be provided as an integrated unit with the low-frequency stimulation pad 241, and in this case, the low-frequency stimulation pad 241 may simultaneously provide low-frequency electrical stimulation and a heating effect to the user, thereby more effectively relieving the user's the muscle pain or menstrual cramps.

The heating device 242 may include a light-emitting diode (LED) for emitting light onto the user's skin surface. The LED may emit infrared or far-infrared rays to the user's skin surface to provide a heating effect to the user, thereby promoting the user's blood flow, relieving pain, promoting recovery, and improving blood flow.

Referring to FIG. 5, the low-frequency stimulation pad 241 and the heating device 242 may be controlled by the user's operation using the belt operation unit 240. By operating the belt operation unit 240, the user may, for example, adjust the intensity, range, cycle, duration, etc. of the low-frequency electrical stimulation provided by the low-frequency stimulation pad 241, or adjust the intensity, range, duration, etc. of the heating effect provided by the heating device 242.

The air belt 2 may include a copper material. The air belt 2 may have high thermal conductivity due to the copper material. Accordingly, the heating effect of the air stretching mat 1 can be better transmitted to the user.

The air belt 2 according to one embodiment of the present invention may be worn around the lumbar region of the user using the Velcro 21 attached to each other on both horizontal end portions thereof and may include a plurality of air tubes 22 extending longitudinally and arranged horizontally. In addition, a pair of low-frequency stimulation pads 241 and a pair of heating devices 242 may be provided on the inner surface of the air belt 2, which are provided horizontally symmetrically, and the belt operation unit 240 for allowing the user to control the low-frequency stimulation pads 241 and the heating devices 242 may be provided on an outer surface of the air belt 2.

According to the present embodiment, the user may wear the air belt 2 and inject air into the air tube 22 to expand the air tube 22 longitudinally, thereby fixing the lumbar region to be prevented from being abruptly bent, folded, or twisted, and providing a continuous traction effect to the lumbar region.

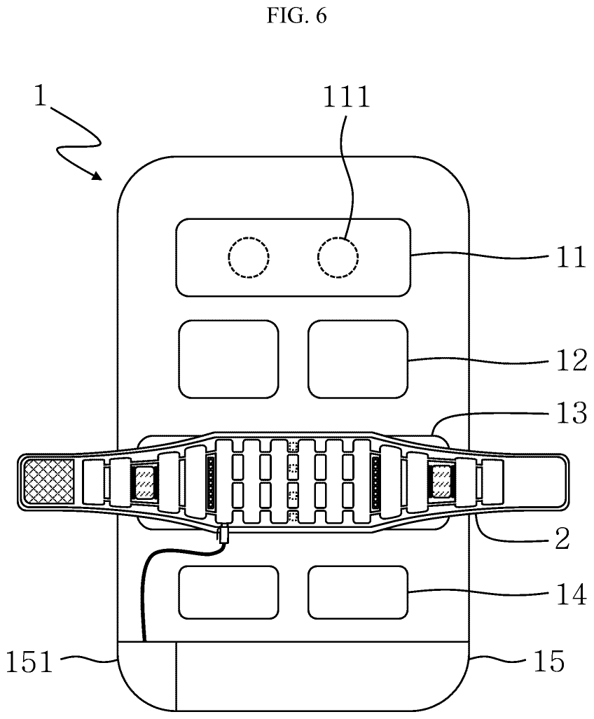

FIG. 6 illustrates a combined air stretching mat and air belt according to one embodiment of the present invention. Referring to the drawing, the user may lie on the air stretching mat 1 while wearing the air belt 2.

The air pump 151 may be connected to the air belt 2. The air pump 151 may be connected to the air belt 2 to inject air into the air tube 22. To this end, the air belt 2 may be provided with a nozzle or valve that protrudes from the air tube 22 and is connected to the air pump 151, and a nozzle or valve that may be connected to the nozzle or valve may extend from the air pump 151.

The connection between the air pump 151 and the air tube 22 may be performed manually by the user's operation in a state in which the user wears the air belt 2, or may be performed automatically by the user lying on the air stretching mat 1. For example, the air pump 151 may include a first valve provided in a central portion of the lumbar-region air chamber 13, and the air belt 2 may include a second valve that is formed complementarily to the first valve and is automatically inserted into or connected to the first valve when the user wears the air belt 2 and lies on the air stretching mat 1.

The air pressure injected into the tube 22 by the air pump 151 may be set to a predetermined appropriate air pressure or lower. In this case, the control unit 15 may block air injection when the appropriate air pressure is injected into the air tube 22. The appropriate air pressure may be determined according to the user's settings or a preset program. Accordingly, the user can be prevented from experiencing impaired blood flow or excessive compression of the skin, muscles, and nerves due to excessive air pressure being supplied to the air belt 2.

The air stretching device may detect the user wearing the air belt 2 and lying on the air stretching mat 1. To this end, the air stretching mat 1 or the air belt 2 may be provided with a predetermined sensor device capable of detecting proximity, contact, connection, engagement, etc. between the air belt 2 and the air stretching mat 1. However, a method of allowing the air stretching device to detect whether the user wears the air belt 2 may include a method of detecting this by the user's operation or input, in addition to such an automatic method.

Referring back to FIG. 3, a belt detection sensor 131 connected to the control unit 15 may be provided on a surface of the lumbar-region air chamber 13. Referring back to FIG. 5, the belt detection target 151 may be provided on a surface of the air belt 2. The belt detection sensor 131 and the belt detection target 151 may be provided at corresponding positions to ensure accurate arrangement between the air stretching mat 1 and the air belt 2. The belt detection sensor 131 and the belt detection target 151 are preferably provided in forms that are arranged or extend in a longitudinal direction at central portions of the surface of the lumbar-region air chamber 13 and the surface of the air belt 2, respectively, in consideration of space utilization, symmetry, accurate position guidance, ease of detection, etc., but the positions and shapes thereof are not limited thereto, as long as they correspond to each other.

The belt detection target 151 may include an electrostatic tag, such as an RFID tag, and in this case, the belt detection sensor 131 may include an electrostatic sensor for detecting contact or approach of the belt electrostatic tag. However, the sensor-detection target unit structure may have various configurations, such as a protrusion of a predetermined shape, a corresponding pressure sensor, etc., and any structure may be used as long as it may detect the user wearing the air belt 2 and lying on the air stretching mat 1.

When the air stretching device detects the user wearing the air belt 2 and lying on the air stretching mat 1, the air stretching device may notify the user that wearing of the air belt 2 has been detected through a predetermined notification unit. The notification unit may use sound or vibration or may be a visual display unit provided on the air belt 2 and/or the air stretching mat 1.

Referring back to FIG. 5, in one embodiment of the present invention, the notification unit may be an LED 25 provided on the belt operation unit 240. In this case, the LED 25 may be turned on when the air stretching device detects the user wearing the air belt 2.

Since the air stretching device may detect the user wearing the air belt 2 and lying on the air stretching mat 1, the control unit 15 may control the air chambers 11, 12, 13, and 14 differently depending on whether the user wears the air belt 2.

For example, the control unit 15 may detect the user wearing the air belt 2 and lying on the air stretching mat 1 and control the air pump 151 to inject air into the air belt 2. This control may be performed in various ways. For example, when the connection between the air pump 151 and the air belt 2 is automatically performed by the user who lies the air stretching mat 1, the air pump 151 may be controlled to inject air into the air belt 2 simply by the user wearing the air belt 2 and lying on the air stretching mat 1. Alternatively, the air pump 151 may be controlled to inject air into the air belt 2 when the user wears the air belt 2, manually connects the air belt 2 to the air pump 151, and then lies on the air stretching mat 1. Alternatively, the air pump 151 may be controlled to inject air into the air belt 2 when the user wears the air belt 2, lies on the air stretching mat 1, and then connects the air belt 2 to the air pump 151.

As another example, the control unit 15 may control the air pressure injected into the lumbar-region air chamber 13 to be a predetermined first maximum pressure or lower when the user does not wear the air belt 2 and control the air pressure injected into the lumbar-region air chamber 13 to be lower than or equal to a predetermined second maximum pressure that is lower than the first maximum pressure when the user wears the air belt 2. Depending on whether the user wears the air belt 2, the maximum air pressure of the lumbar-region air chamber 13 may vary, and thus the pressure applied to the lumbar region of the user may be adjusted so as not to be excessive. In particular, when the lumbar region receives excessive forward pressure, hyperextension of the lumbar region may occur, and thus it is necessary to reduce the pressure applied by the lumbar-region air chamber 13 to the lumbar region of the user, which is continuously under pressure from the air belt 2.

Referring back to FIG. 3, a hyperextension detection sensor 132 connected to the control unit 15 may be provided on the surface of the lumbar-region air chamber 13. Referring back to FIG. 5, in this case, the hyperextension detection target 232 may be provided on the surface of the air belt 2. The hyperextension detection sensor 132 and the hyperextension detection target 232 may be provided at corresponding positions.

The hyperextension detection sensor 132 may be provided as a symmetrical pair or multiple pairs at positions spaced apart from each other by a predetermined distance on both sides of the widthwise center of the surface of the lumbar-region air chamber 13. In this case, the hyperextension detection units 232 may be provided as a symmetrical pair or multiple pairs at positions spaced apart from each other by a predetermined distance on both sides of the widthwise center of the surface of the air belt. However, alternatively, the hyperextension detection sensors 132 may be provided at one or a pair of positions spaced apart from each other by a predetermined distance toward one side from the widthwise center of the surface of the lumbar-region air chamber 13, and in this case, the hyperextension detection units 232 may also be provided at one or a pair of positions spaced apart from each other toward one side from the widthwise center of the surface of the air belt 2.

The air belt 2 and the air stretching mat 1 according to one embodiment of the present invention may be connected. In addition, in this case, the air stretching mat 1 may include the belt detection sensor 131 and a pair of hyperextension detection sensors 132 provided at the center of the surface of the lumbar-region air chamber 13 and on both sides thereof in the width direction, respectively, and the air belt 2 may include the belt detection target 151 and the hyperextension detection target 232 provided at the center of the surface thereof and on both sides thereof in the width direction, respectively.

According to the present embodiment, when the user wears the air belt 2 and lies on the air stretching mat 1, the air belt 2 and the air stretching mat 1 may operate in conjunction with each other by injecting air into the air belt 2 or adjusting the air pressure of the lumbar-region air chamber 13. According to this linkage, the air stretching device may control the pressure provided to the lumbar region of the user from the air belt 2 and the air stretching mat 1 so as not to be excessive, thereby improving its safety, providing various functions that the air belt 2 or the air stretching mat 1 could not provide independently, and improving its convenience with respect to air injection into the air belt 2 or the like.

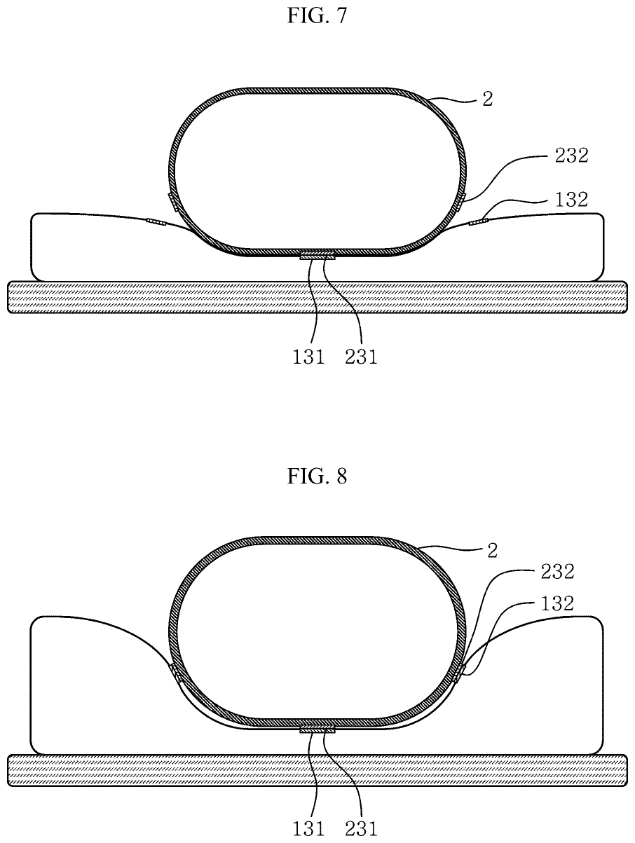

FIGS. 7 and 8 illustrate a hyperextension detection function according to one embodiment of the present invention. Referring to these drawings, when the air pressure in the lumbar-region air chamber 13 increases while the user wears the air belt 2 and lies on the air stretching mat 1, the central portion of the lumbar-region air chamber 13 may be restricted from expanding due to the user's body weight, and both sides of the lumbar-region air chamber 13 may expand and rise. In this case, when the air pressure of the lumbar-region air chamber 13 becomes a predetermined pressure or higher, the hyperextension detection sensor 132 may rise and approach the hyperextension detection target 232 to detect the hyperextension detection target 232.

In this case, the control unit 15 may control the air pressure of the lumbar-region air chamber 13 to no longer increase when the hyperextension detection target 232 is detected by the hyperextension detection sensor 132. That is, the control unit 15 may stop the air injection into the lumbar-region air chamber 13 when the hyperextension detection sensor 132 detects the hyperextension detection target 232.

The predetermined pressure at which the hyperextension detection sensor 132 detects the hyperextension detection target 232 may vary depending on the distances by which the hyperextension detection sensor 132 and the hyperextension detection target 232 are spaced apart from the widthwise center of the surface of the lumbar-region air chamber 13 and the air belt 2, respectively. Accordingly, by setting the predetermined pressure to be lower than or equal to the pressure at which the lumbar region of the user begins to hyperextend and setting the positions of the hyperextension detection sensor 132 and the hyperextension detection target 232 correspondingly, the detection of the hyperextension detection target 232 by the hyperextension detection sensor 132 may be used as an indicator of the risk of hyperextension of the lumbar region of the user. In this case, by limiting the increase in air pressure in the lumbar-region air chamber 13, the hyperextension of the lumbar region of the user can be prevented.

### Air Stretching Method

Next, an air stretching method using the air stretching device according to one embodiment of the present invention will be described with reference to the drawings.

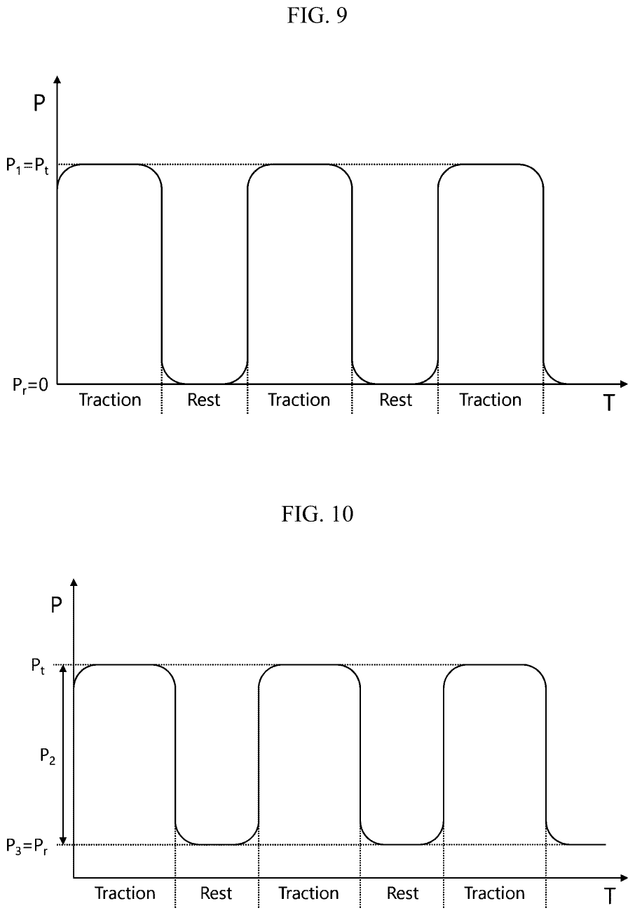

FIGS. 9 and 10 are graphs illustrating the pressure applied to a lumbar region of a user over time in an air stretching method according to one embodiment of the present invention.

Traction therapy used to treat herniated discs includes intermittent traction and continuous traction. The intermittent traction may be performed by repeatedly applying traction to the user's spine for a predetermined traction time followed by allowing the user to rest for a predetermined rest time. The continuous traction may be performed by applying traction to the user's spine with a relatively weak intensity for a relatively long time.

An air stretching method according to one embodiment of the present invention can provide the intermittent traction effect by including a traction operation of continuously providing, by the air stretching device, air pressure that is a predetermined set traction pressure Pt or higher to the lumbar region of the user for a predetermined traction time, and a rest operation of continuously providing, by the air stretching device, air pressure that is a predetermined set rest pressure Pr or lower to the lumbar region of the user.

The traction operation and the rest operation may be alternately repeated. The traction operation is preferably set to about 7 seconds, for example, 5 to 10 seconds. The rest operation is preferably set to about 5 to 7 seconds, for example, 3 to 10 seconds.

The set rest pressure Pr is preferably lower than the set traction pressure Pt. In this case, when the set rest pressure Pr is zero, the air stretching method can provide an intermittent traction effect.

When the set rest pressure Pr is equal to the set traction pressure Pt, that is, when the pressure applied to the lumbar region of the user remains constant, the air stretching method can provide a continuous traction effect.

When the set rest pressure Pr is lower than the set traction pressure Pt and the set rest pressure Pr is greater than zero, the air stretching method can simultaneously provide both the intermittent traction effect and the continuous traction effect. In this case, the smaller a difference between the set rest pressure Pr and the set traction pressure Pt, the less the air stretching method can provide the intermittent traction effect and the continuous traction effect.

The air stretching method according to one embodiment of the present invention may use the air stretching device in a plurality of different modes, thereby providing the intermittent traction and the continuous traction to the user separately or simultaneously.

Hereinafter, each mode of the air stretching method will be described.

### Intermittent Traction Mode

The user may receive the intermittent traction effect as follows using the air stretching mat according to one embodiment of the present invention.

FIG. 9 illustrates the pressure applied to the lumbar region of the user over time when using the air stretching mat without wearing an air belt. Referring to this, when the user does not wear the air belt, the lumbar-region air chamber 13 may be controlled to maintain a predetermined first traction pressure P1 during the traction time and maintain a zero air pressure during the rest time.

In this case, since the pressure received by the lumbar region of the user is equal to the pressure provided to the lumbar region of the user by the lumbar-region air chamber, the preset traction pressure Pt may be equal to the first traction pressure P1, and the preset rest pressure Pr may be set to zero. In this case, the air stretching method can only provide the intermittent traction effect without the continuous traction effect.

### Continuous Traction Mode

The user may also receive the continuous traction effect using the air belt according to one embodiment of the present invention, as follows.

When the user wears the air belt and connects the air belt to the air pump, air pressure may be charged into the air tube. In this case, the pressure charged into the air belt may be set to a predetermined belt traction pressure.

As described above, the charging of the air belt's air pressure may be initiated by the user's operation or automatically initiated by the control unit's automatic detection and terminated when the air pressure reaches the belt traction pressure.

By wearing the air belt charged with the belt traction pressure as described above, the lumbar region of the user may receive the continuous traction from the air belt equivalent to the belt traction pressure.

According to the continuous traction method using the air belt, the user may continue his/her daily activity while wearing the air belt, enabling long-term continuous traction.

The continuous traction may be terminated arbitrarily by the user releasing the air pressure from the air belt or removing the air belt, or automatically by the control unit controlling the air pump to release the air pressure from the air belt.

### Intermittent and Continuous Traction Modes

According to one embodiment of the present invention, the user may simultaneously or alternately receive the intermittent and continuous traction effects using the air stretching mat while wearing the air belt, as will be described below.

FIG. 10 illustrates the pressure applied to the lumbar region of the user over time when wearing the air belt and using the air stretching mat. Referring to this, when the user wears the air belt, the lumbar-region air chamber 13 may maintain a predetermined second traction pressure P2 that is lower than the first traction pressure P1 during the traction time and maintain a zero air pressure during the rest time.

In this case, the pressure provided to the user by the air belt may be set to a predetermined belt traction pressure P3. Accordingly, the pressure applied to the lumbar region of the user becomes equal to the sum of the pressure provided to the lumbar region of the user by the lumbar-region air chamber and the pressure provided to the user by the air belt. Accordingly, the set traction pressure Pt may be equal to the sum of the second traction pressure P2 and the belt traction pressure P3, and the set rest pressure Pr may be equal to the belt traction pressure P3. In this case, the air stretching method may simultaneously provide the continuous traction effect equivalent to the belt traction pressure P3 and the intermittent traction effect equivalent to the second traction pressure P2.

The air stretching method may enable the simultaneous use of the air belt and the air stretching mat as described above, thereby allowing stable continuous traction and the simultaneous or alternating performance of the intermittent traction.

In particular, according to the present embodiment, by enabling the simultaneous use of the air belt and the air stretching mat, the lumbar region of the user may be provided with stable continuous and intermittent traction at a relatively high intensity more safely, without being subjected to excessive upward pressure causing hyperextension.

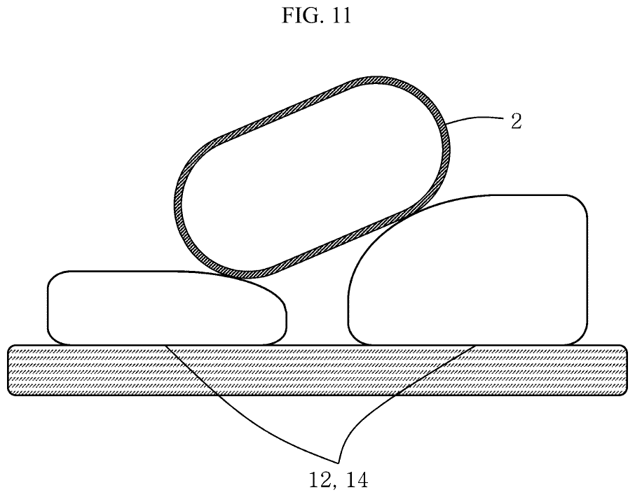

FIG. 11 illustrates a posture change assisting operation in the air stretching method according to one embodiment of the present invention. Referring to this, the air stretching method may further include a posture change assisting operation of increasing an air pressure on one side in a left-right direction compared to an air pressure on the other side in step in at least any one of the thoracic-region air chamber 12 and the sacrococcygeal-region air chamber 14. When the user wears the air belt 2, it may be difficult for the user to bend the waist, limiting the operation to stand up or turn over. In this case, by performing the posture change assisting operation according to the operation of the control unit or a set program, the user's body can be more easily twisted to one side to facilitate rising.

The above embodiments should be understood in all aspects as illustrative and not restrictive, and the scope of the present invention will be determined by the appended claims rather than the above-described detailed description. In addition, not only the meanings and scopes of the appended claims but also all changeable or modifiable forms derived from the equivalent concept thereof should be construed as being included in the scope of the present invention.

Although the present invention has been described above with reference to the exemplary drawings, the present invention is not limited by the embodiments and drawings disclosed in the specification, and it is apparent that various modifications can be made by those skilled in the art within the scope of the technical spirit of the present invention. In addition, even when the operational effects according to the configuration of the present invention have not been explicitly described in the description of the embodiments of the present invention, it goes without saying that the effects predictable by the corresponding configuration should also be recognized.

1. An air stretching device comprising;
a control unit;
a plurality of air chambers controlled by the control unit such that an air pressure thereof increases or decreases and including lumbar-region air chambers corresponding to a lumbar region of a user; and
an air belt, which is wearable around the lumbar region of the user and includes a plurality of air tubes,
wherein the control unit includes an air pump which is connected to the air tubes and enables air injection.

2. The air stretching device of claim 1, wherein the air belt includes a low-frequency stimulation pad which is provided on an inner surface thereof and provides heating and low-frequency electrical stimulation to the user.

3. The air stretching device of claim 2, wherein the air belt includes a belt operation unit configured to adjust an intensity of the heating and low-frequency electrical stimulation provided by the low-frequency stimulation pad.

4. The air stretching device of claim 1, wherein the control unit blocks the air injection when a predetermined appropriate air pressure is injected into the air tubes.

5. The air stretching device of claim 1, which detects the user wearing the air belt.

6. The air stretching device of claim 5, wherein a belt detection sensor connected to the control unit is provided on a surface of the lumbar-region air chamber or a back surface of the air belt,
a belt detection target is provided on the back surface of the air belt or the surface of the lumbar-region air chamber, and
the belt detection sensor detects that the belt detection target comes into contact with the belt detection sensor or approaches within a predetermined distance from the belt detection sensor and outputs a belt detection signal to the control unit.

7. The air stretching device of claim 6, wherein the belt detection target includes an electrostatic tag, and
belt detection sensor includes an electrostatic sensor configured to detect contact or approach of the electrostatic tag.

8. The air stretching device of claim 5, wherein the air pressure injected into the lumbar-region air chamber by the control unit is controlled to be a predetermined maximum air pressure or lower,
when the user does not wear the air belt, the maximum air pressure is controlled to be a first maximum pressure or lower, and
when the user wears the air belt, the maximum air pressure is controlled to be lower than or equal to a second maximum pressure which is lower than the first maximum pressure.

9. The air stretching device of claim 5, wherein, when the user wears the air belt and lies on the air stretching device, the air pump is controlled to inject air into the air belt.

10. The air stretching device of claim 1, which detects hyperextension of the lumbar region of the user.

11. The air stretching device of claim 10, wherein a pair of hyperextension detection sensors are provided at positions spaced apart from each other by a predetermined distance on both sides of a widthwise center of a surface of the lumbar-region air chamber or a back surface of the air belt,
a pair of hyperextension detection targets are provided at positions spaced apart from each other by a predetermined distance on both sides of the widthwise center of the back surface of the air belt or the surface of the lumbar-region air chamber, and
the hyperextension detection sensors detect that the hyperextension detection targets come into contact with the hyperextension detection sensors or approach within a predetermined distance and output a hyperextension detection signal to the control unit.

12. The air stretching device of claim 10, wherein, when the hyperextension of the lumbar region of the user is detected, air injection into the lumbar-region air chamber is controlled so as to stop further injection.

13. The air stretching device of claim 1, comprising:
a lower mat whose temperature is controlled to increase or decrease by the control unit; and
an upper mat provided above the lower mat,
wherein the upper mat includes at least one of ceramic, artificial stone, and natural stone.

14. The air stretching device of claim 1, wherein the air belt includes a copper material.

15. The air stretching device of claim 1, comprising a roller controlled by the control unit to rotate and travel at a position corresponding to a cervical region of the user.

16. An air stretching method using an air stretching device including a control unit, and a lumbar-region air chamber controlled by the control unit to increase or decrease air pressure and corresponding to a lumbar region of a user, the method comprising:
a traction operation of maintaining, by the lumbar-region air chamber, an air pressure at a predetermined traction pressure or higher for a predetermined traction time; and
a resting operation of maintaining, by the lumbar-region air chamber, an air pressure at a predetermined rest pressure or lower for a predetermined rest time.

17. The air stretching method of claim 16, wherein the air stretching device includes an air belt that is wearable around the lumbar region of the user and has a plurality of air tubes,
when the user does not wear the air belt, the traction pressure is controlled to be a first traction pressure or higher, and
when the user wears the air belt, the traction pressure is controlled to be a second traction pressure or higher, which is lower than the first traction pressure.

18. The air stretching method of claim 16, wherein the air stretching device includes:
a thoracic-region air chamber corresponding to a thoracic region of the user; and
a sacrococcygeal-region air chamber corresponding to sacral and coccyx regions of the user, and
the air stretching method further comprises a posture change assisting operation of increasing an air pressure on one side in a left-right direction compared to an air pressure on the other side in at least one of the thoracic-region air chamber and the sacrococcygeal-region air chamber.
